(19) United States
(12) Patent Application Publication
(10) Pub. No.: US 2012/0088694 A1
(43) Pub. Date: Apr. 12, 2012

(54) CELL ASSAY METHODS AND ARTICLES

(75) Inventors: Saju Nettikadan, Hawthorne Woods, IL (US); John Michael Collins, West Chicago, IL (US); Alexander B. Smetana, Park Ridge, IL (US); Paul Leon Stiles, Naperville, IL (US)

(73) Assignee: NanoInk, Inc.

(21) Appl. No.: 13/251,786

(22) Filed: Oct. 3, 2011

Related U.S. Application Data
(60) Provisional application No. 61/391,044, filed on Oct. 7, 2010.

(51) Int. Cl. C40B 40/04; C40B 50/14; B82Y 15/00

(52) U.S. Cl. 506/15; 506/30; 977/773

(57) ABSTRACT

Versatile, efficient cell assays which can be prepared with use of nanolithography and can be used to test nanomaterials, pharmaceuticals, toxins, and the like. For example, a method comprising: depositing at least one first composition comprising at least one cell adhesion material on at least one substrate to form a pattern which forms an interior space on the substrate within the pattern, depositing in the interior space on the substrate at least one second composition, different from the first, comprising at least one material adapted to affect or potentially affect cell function. Tip-based deposition and direct-write methods can be used for deposition at nanoscale and sub-cellular resolutions. Nanoscopic and atomic force microscope tips can be used. Multiplexing can be carried out.

### RELATED APPLICATIONS

This application claims priority to U.S. provisional application Ser. No. 61/391,044 filed Oct. 7, 2010, which is hereby incorporated by reference in its entirety.

### BACKGROUND

A need exists to develop faster, more versatile, and more efficient methods and devices for assaying cells. For example, better sub-cellular methods are needed. Better ability to quantitate assays at more sensitive levels is needed. Better statistical methods are needed which provide better reproducibility. In addition, a need exists so one can use cell assays for examining the positive and negative effects of substances such as nanoscale substances. Nanoscale materials may be more reactive compared to bulk form. In addition, one particularly important goal is ability to carry out single cell assaying.

Nanotechnology and nanostructured surfaces provide an important arena for innovation at the sub-cellular level. Nanoscale biotechnology is discussed in, for example, Mirkin, Niemeyer (Eds.), Nanobiotechnology II, 2007 and Greco, Prinz, and Smith (Eds.), Nanoscale Technology in Biological Systems (2005).

### SUMMARY

Embodiments described herein include, for example, methods of making, methods of using, and devices.

For example, one embodiment provides a method comprising: depositing at least one first composition comprising at least one cell adhesion material on at least one substrate to form a pattern which, optionally, forms an interior space on the substrate within the pattern, depositing on the substrate at least one second composition, different from the first, comprising at least one material adapted to affect or potentially affect cell function, wherein after deposition of the first composition and the second composition, optionally, the second composition is disposed in the interior space.

In one embodiment, depositing of the first composition occurs before depositing of the second composition, or the depositing of the second composition occurs before depositing of the first composition.

In one embodiment, the second composition further comprises at least one gel. In one embodiment, the second composition further comprises at least one hydrogel. In one embodiment, the second composition further comprises at least one synthetic polymer. In one embodiment, the second composition further comprises at least one biodegradable material. In one embodiment, the second composition comprises at least one material adapted to provide controlled release of the material adapted to affect or potentially affect cell function. In one embodiment, the second composition comprises at least one encapsulant.

In one embodiment, the first composition deposition step is carried out with at least one tip to transfer the first composition to the substrate. In one embodiment, the first composition deposition step is carried out with at least one nanoscopic tip to transfer the first composition to the substrate. In one embodiment, the second composition deposition step is carried out with a least one tip to transfer the second composition to the substrate. In one embodiment, the second composition deposition step is carried out with a least one nanoscopic tip to transfer the biodegradable material to the substrate.

In one embodiment, the methods further comprise the step of binding at least one cell to the pattern. In one embodiment, the method further comprises the step of binding one cell to five cells to the pattern, or only one cell to the pattern. In one embodiment, the method further comprises the step of binding about one cell to the pattern.

In one embodiment, the method further comprises treating the substrate with a material adapted to prevent non-specific cell binding.

In one embodiment, the cell adhesion material comprises at least one protein or peptide. In one embodiment, the cell adhesion material comprises at least one extracellular matrix. In one embodiment, the cell adhesion material comprises at least one cell receptor.

In one embodiment, the material adapted to affect or potentially affect cell function comprises at least one nanomaterial. In one embodiment, the material adapted to affect or potentially affect cell function comprises at least one pharmaceutical drug. In one embodiment, the one material adapted to affect or potentially affect cell function comprises at least one toxin.

In one embodiment, the substrate is a rigid substrate. In one embodiment, the substrate is a flexible substrate.

In one embodiment, the deposition of the first composition forms a plurality of dots, and the pattern of dots is a square or rectangle. In one embodiment, the pattern has a lateral dimension of less than about 100 microns. In one embodiment, the pattern has a lateral dimension of less than about 50 microns. In one embodiment, the deposition of the first composition and the deposition of the second composition produce dots on the substrate with dot diameter of less than about one micron. In one embodiment, the deposition of the first composition is reproduced to produce at least two patterns on the same substrate with internal space.

In one embodiment, the pattern forms an interior space on the substrate within the pattern, wherein after deposition of the first composition and the second composition, the second composition is disposed in the interior space, wherein the deposition of the first composition and the deposition of the second composition are each carried out by direct write methods, wherein the second composition further comprises at least one hydrogel, wherein the first composition deposition step is carried out with at least one tip to transfer the first composition to the substrate, and wherein the second composition deposition step is carried out with a least one tip to transfer the second composition to the substrate.

Another embodiment provides a product prepared by these and other processes described herein.

One additional embodiment provides a method comprising: depositing at least one first composition comprising at least one cell adhesion material on at least one substrate to form a pattern which forms an interior space on the substrate within the pattern, depositing in the interior space on the substrate at least one second composition, different from the first, comprising at least one material adapted to affect or potentially affect cell function. In this embodiment, the first composition can be deposited first, followed by deposition of the second composition. Alternatively, the second composition can be deposited first, followed by deposition of the first composition. Another embodiment provides a product prepared by this process.

Another embodiment provides an article comprising: at least one substrate comprising at least one pattern of cell adhesion material, wherein the pattern, optionally, forms an interior space on the substrate within the pattern, at least one material, optionally, in the interior space on the substrate, wherein the material adapted to affect or potentially affect cell function. Another embodiment provides an article comprising: at least one substrate comprising at least one pattern of cell adhesion material, wherein the pattern forms an interior space on the substrate within the pattern, at least one material in the interior space on the substrate, wherein the material adapted to affect or potentially affect cell function.

In one embodiment, the material adapted to affect or potentially affect cell function is adapted for controlled release. In one embodiment, the material adapted to affect or potentially affect cell function is adapted for controlled release from a gel. In one embodiment, the material adapted to affect or potentially affect cell function is adapted for controlled release from a hydrogel.

In one embodiment, the article further comprises at least one cell disposed on the pattern. In one embodiment, the article further comprising at least one material on the surface of the substrate which is adapted to prevent non-specific cell binding.

In one embodiment, the pattern comprises a series of dots. In one embodiment, the pattern comprises a rectangle or square. In one embodiment, the pattern has a lateral dimension of about 100 microns or less.

In one embodiment, the pattern forms an interior space on the substrate within the pattern, and the at least one material which is adapted to affect or potentially affect cell function is disposed in the interior space on the substrate.

Another embodiment provides a microarray comprising: at least one substrate, at least one cell binding pattern fixed on the substrate and binding one or more cells, wherein each of the cell binding patterns is capable of binding no more than five cells; at least one hydrogel pattern fixed on the substrate and different from the cell binding pattern, wherein each of the hydrogel patterns comprises a cell assay material adapted to be released to contact cells bound to the cell binding pattern, wherein the substrate is further blocked in areas not occupied by the cell binding patterns or hydrogel patterns to prevent non-specific cell binding.

Another embodiment provides a method comprising: depositing at least one first composition comprising at least one cell adhesion material on at least one substrate to form a pattern which forms an interior space on the substrate within the pattern, depositing in the interior space on the substrate at least one second composition, different from the first, comprising at least one material adapted to affect or potentially affect cell function.

Another embodiment provides a method for producing microarrays comprising: fixing multiple hydrogel patterns onto a substrate, wherein each of the hydrogel patterns comprises a cell assay material, locating the hydrogel patterns being fixed on the substrate, fixing multiple cell binding patterns onto the substrate next to the hydrogels, blocking areas of the substrate not occupied by the cell binding pattern or the hydrogel patterns.

Another embodiment provides a method comprising: depositing at least one first composition comprising at least one cell adhesion material on at least one substrate to form a pattern which, optionally, forms an interior space on the substrate within the pattern, depositing on the substrate at least one second composition, different from the first, comprising at least one material adapted to affect or potentially affect cell function, wherein after deposition of the first composition and the second composition, optionally, the second composition is disposed in the interior space, wherein the pattern totally surrounds the interior space or the pattern only partly surrounds the interior space. In one embodiment, the method of claim 50, wherein the pattern totally surround the interior space. In one embodiment, the pattern comprises dots which totally surround the interior space. In one embodiment, the pattern comprises dots which do not touch one other and which totally surround the interior space.

Other embodiments provide for kits which comprises, for example, instructions to use the kits and at least one, or at least two components, described herein. For example, a kit is provided which is adapted for a cellular assay, wherein the kit comprises at least one of (i) instructions to use the kit for cellular assay, (ii) at least one substrate, (iii) at least one cellular adhesion material, (iv) at least one one material for cellular assay, (v) an encapsulant.

At least one advantage for at least one embodiment includes ability to place cells at defined locations on a substrate surface and address the cells with multiple components.

At least one advantage for at least one embodiment include versatility. For example, different shapes can be relatively easily created to test different types of cells. The pattern can be inexpensively changed. Multiple components can be printed simultaneously. The amount of material printed can be controlled, and the location can be precisely controlled.

At least one additional advantage for at least one embodiment includes high cell attachment including, for example, greater than 75%, or greater than 90%, or greater than 95%, or 100%.

At least one additional advantage for at least one embodiment includes no clean room is needed. In another embodiment, photolithography can be avoided.

At least one additional advantage for at least one embodiment includes ability to test a single cell, or to test a small group of cells.

At least one additional advantage is ability to carry out single cell assays. Features can be easily created with are much smaller than the average size of a cell (e.g., 50 microns or less). Assay arrays can be created that can fit beneath a single cell. Specific binding to cells can be achieved.

Combinations of advantages can be important including the combination of accuracy, control, and scalability.

### BRIEF DESCRIPTION OF FIGURES

FIG. 1 illustrates one embodiment in a perspective view, including an expanded view below, for patterning a cell adhesion material.

FIG. 2 illustrates one embodiment in a perspective view, including an expanded view below, for patterning a material, which may affect a cell, within the pattern of cell adhesion material.

FIG. 3 illustrates one embodiment in a cross-sectional view showing cell binding material on the outside and biodegradable hydrogels for encapsulating substances on the inside. A top view is also provided.

FIG. 4 illustrates one embodiment in a cross-sectional view where the cell is added to a structure such as shown in FIG. 3. The cell attaches to the cell adhesion material and interacts with the hydrogel. A top view is also provided. The cell nucleus is shown.

FIG. 5 illustrates an embodiment for a substrate patterning motif showing a control based on a cell adhesion material (red) and three different substances, A (blue), B (green), and C (yellow), which can affect the cell and is in the interior of the cell adhesion material.

FIG. 6 illustrates one embodiment, derived from FIG. 5, where the attached cells are shown.

FIG. 7 illustrates two embodiments showing fibronectin dot patterns in two motifs (3×3, left) and (2×2, right) with cell binding. The scale bar is 50 microns.

FIG. 8 illustrates six embodiments for cell binding to underlying cell attachment patterns.

FIG. 9 illustrates in a schematic view one embodiment of the fabrication of the hydrogel patterns described herein.

FIG. 10 illustrates one embodiment showing the images and average fluorescence intensity of fibroblasts cultured for 2 hours on the hydrogel patterns described herein.

FIG. 11 illustrates one embodiment showing the time course following spreading and migration of fibroblasts on the hydrogel patterns described herein over a period of 4 hours.

FIG. 12 illustrates one embodiment comparing the morphology of the fibroblasts after four hours of treatment with either hydrogel comprising Cytochalasin D or control hydrogel.

### DETAILED DESCRIPTION

### Introduction

All references cited herein are incorporated by reference in their entirety.

One embodiment provides a method comprising: depositing at least one first composition comprising at least one cell adhesion material on at least one substrate to form a pattern which, optionally, forms an interior space on the substrate within the pattern, depositing on the substrate at least one second composition, different from the first, comprising at least one material adapted to affect or potentially affect cell function, wherein after deposition of the first composition and the second composition, optionally, the second composition is disposed in the interior space.

Additional embodiments provided herein provide, among other things, a method to place cells at defined locations on a surface and address those cells with multiple components. In one embodiment, for example, one can construct a pattern of cell adhesion domains. Within this pattern, for example, biodegradable materials, such as a gel or hydrogel, can be placed which comprises a material which can potentially affect or can affect cell function. These patterns can be, for example, then exposed to a cell of interest. The cells can bind to the cell adhesion domains and are in contact with biodegradable gels. Over time, the materials within the gels can be released and only cells that are in contact with these patterns can be exposed. By controlling the dimension of the cell binding domains, one can ensure that only one or a small number of cells bind to each pattern. Other embodiments are described herein.

### Substrate

Substrates known in the art for biological arrays can be used. Substrates can be rigid or flexible. They can be flat or they can have depressions, grooves, wells, protrusions, or other surface physical features. They can comprise glasses or plastics. They can be membranes.

One preferred example is a glass substrate including high quality low fluorescence glass. Embodiments include a glass slide or a glass cover slip. Patterning can be carried out edge-to-edge if desired. Patterning can be carried out over an entire glass slide.

The substrate can be surface treated if desired to facilitate deposition. The substrate can be cleaned. The substrate can be treated to be hydrophilic or hydrophobic.

The substrate can be also called a chip. The chip can be rectangular or square. The length and width can be, for example, 1 mm to 100 mm or 5 mm to 50 mm.

The substrate thickness can be, for example, 50 microns to 500 microns, or about 100 microns to about 250 microns.

Substrates used in nanolithography can be used including, for example, substrates described in U.S. Pat. Nos. 6,635,311; 6,827,979; and 7,744,963 (Mirkin et al.).

Substrates can be modified with surface treatments including treatments relevant to cellular adhesion and the blocking of cellular adhesion. See, for example, U.S. Pat. No. 7,695,967.

Substrates can be marked to show addressable sites. The substrate can show grids, horizontal lines, vertical lines, indicia and markings, and other identification features.

### Deposition of at Least One First Composition Comprising Cell Adhesion Material

Deposition methods are known in the art including direct write deposition and nanolithography methods. Direct write methods are described in, for example, Pique, Chrisey (Eds.), Direct-Write Technologies for Rapid Prototyping Applications, 2002. Examples include ink jet printing (Chapter 7), micropen printing (Chapter 8), thermal spraying (Chapter 9), Dip-Pen Nanolithographic printing (Chapter 10), electron beam lithography (Chapter 11), focused ion beam (Chapter 12), laser-related methods including micromachining (Chapters 13-17),

The deposition can form a deposition shape. One or more deposition shapes can further form a pattern. The shapes and patterns can be repeated across the substrate surface. The size, shape, and chemical functionality of the deposition shape and pattern can be adapted to control binding. See, for example, U.S. Pat. No. 7,569,340.

One deposition example is use of a tip which comprises a material to be deposited on the end of the tip, and transferring the material from the tip to the substrate. If the tip is held stationary with respect to the substrate, the deposition can result in a dot or disc formation. For example, the dot or disc can be characterized by a diameter. If the tip is moved with respect to the substrate, a line or curvilinear feature can be prepared. The line can be formed into a larger pattern such as a square or rectangle. In addition, a series of dots can be also patterned into a square or rectangle. Other shapes can include, for example, crossbows, H's, or Y's, or triangles.

Deposition methods include microcontact printing and DPN printing.

Nanolithography methods can be used including, for example, methods described in U.S. Pat. Nos. 6,635,311; 6,827,979; and 7,744,963 (Mirkin et al.). Additional methods are described in, for example, U.S. Pat. No. 7,344,756, WO 2010/096593, and WO 2009/132,321 (Mirkin et al.). Furthermore, patterning devices, including tips and cantilevers and associated methods, are described in, for example, U.S. provisional application 61/324,167 filed Apr. 14, 2010. Protein arrays can be prepared by deposition methods as described in, for example, Mirkin et al., “PEPTIDE AND PROTEIN ARRAYS AND DIRECT-WRITE LITHOGRAPHIC PRINTING OF PEPTIDES AND PROTEINS,” US Patent Publication 2005/0009206; and Mirkin et al., “PEPTIDE AND PROTEIN NANOARRAYS,” US Patent Publication 2003/0068446.

Examples of tips include nanoscopic tips, scanning probe microscope tips, atomic force microscope tips, and the like.

Tips can be disposed at the end of a cantilever. Single tips or dual tips can be used.

In addition, arrays of tips can be used. For example, one-dimensional or two-dimensional arrays can be used.

Deposition can be carried out with use of instruments, devices, and consumables provided by Nanolnk (Skokie, Ill.) including, for example, the NLP 2000 and DPN 5000 instruments. Other products include pens and pen arrays, chips, substrates, and inkwells.

The deposition can produce dots or lines on the substrate. A series of dots can be formed which are arranged in linear manner.

The size of the shapes and patterns can be adapted to conform to the application and the size of the cell. Physical changes, as well as chemical changes, on the cell can be determined.

The pattern can be shaped so that is completely or substantially completely surrounds an interior space. For example, a circle or square could be formed. However, the pattern also can be shaped so it does not fully enclose an interior space. For example, a hemicircle or arc can be used rather than a full circle. Or a V or U shaped pattern can be formed (half a square or half a rectangle).

Deposition can be carried out so the individual pattern comprises, for example, five to 5,000 dots, or five to 1,000 dots, or five to 100 dots. The deposition can be carried out so the substrate comprises, for example, one or more, ten or more, 50 or more, or 100 or more patterns. No fixed upper limit is present but the substrate can comprise less than 5,000 individual patterns, or less than 1,000, or less than 100 individual patterns.

### Pattern Forming Interior Space

Patterning of the first composition can be, if desired, carried out in a way to form a boundary region for interior space. For example, a rectangle or square can be patterned which forms a boundary region for interior space. A plurality of these patterns can be disposed on the substrate. For example, a series of squares or a series of rectangles, each square and rectangle comprising dots, can be disposed on the substrate.

The distances between patterned areas can be controlled. For example, an edge-to-edge distance can be, for example, less than 100 microns, or less than 10 microns, or less than 1 micron, or less than 500 nm.

The interior space can be characterized by a square area which can be, for example, 100 square microns to 25,000 square microns, or five hundred square microns to 10,000 square microns.

### Cell Adhesion Material

Ink formulations can be made comprising at least one cell adhesion material. The ink formulation can comprise at least one solvent. It can be formulated to provide effective deposition. For example, the viscosity, surface tension, and hydrophilicity of the ink can be controlled.

Cell adhesion materials are known in the art. Examples include extracellular matrix (ECM) proteins such as fibronectin, laminin, collagen I, collagen IV, gelatin, poly-I-lysine, BD ECM (commercially available mixture of ECM proteins from BD Biosciences), BD Matrigel, tenacin C, vitronectin, and the like. Other examples include cell receptors.

For example, fibronectin micropatterns are described in Kwon et al., Genes & Development, 2008 (“Mechanisms to Suppress Multipolar Divisions in Cancer Cells with Extra Centrosomes”). Extracellular matrix patterned by microcontact printing is described in Thery, et al., Nature Cell Biology, 7, 10, 947-953, 2005 (“The Extracellular Matrix Guides the Orientation of the Cell Division Axis”). Adhesive micropatterns are also described in Thery et al., Nature, 1-5, 2007 (“Experimental and Theoretical Study of Mitotic Spindle Orientation”).

Cell adhesion materials are also described in, for example, M. C. Beckerle (Ed.), Cell Adhesion, 2001.

### Deposition of at Least One Second Composition

The deposition methods described above for the deposition of cell binding materials also can be used for deposition of the second composition, which is different than the first composition. For example, direct write methods can be used. Stamping methods can be used. Tip-based methods can be used.

The second composition can be adapted for the deposition method. The second composition can be adapted to be an ink formulation, and can comprise at least one solvent.

The second composition can comprise at least one material adapted to affect or potentially affect cell function. Examples of the material adapted to affect or potentially affect cell function include Cytochalasin D.

### Material Adapted to Affect or Potentially Affect Cell Function

Many materials can be tested for their effect or potential effect on cell function. Examples include drug molecules, toxins, nanomaterials, nanoparticles, nanotubes, carbon nanotubes, proteins, and the like. Other assays are described below.

### Additional Components in the Second Composition

The second composition can further comprise at least one additional component such as, for example, a gel, a hydrogel, a synthetic polymer, and/or a biodegradable material. Examples of the additional component include Eudragit, gelatin, PLGA, and the like.

Examples of gels and hydrogels are describe in, for example, Stiles et al, U.S. patent Ser. No. 12/835,681 filed Jul. 13, 2010 (“Methods for Forming Hydrogels on Surfaces . . . ”).

Hydrogels can be generally understood to be lightly crosslinked networks of water soluble polymers before crosslinking Hydrogels typically are capable of absorbing, or swelling, but not dissolving in, water. Hydrogels find use in many applications due, in part, to their unique physical properties, including high porosity and the ability to absorb significant quantities of water. For example, drug molecules and nanomaterials can be loaded into the pores of hydrogels and released over time. See, e.g., Hoare, T. R. et al., “Hydrogels in Drug Delivery: Progress and challenges, Polymer 49 (2008) 1993-2007 and Kopecek, J., “Hydrogel Biomaterials: A Smart Future?,” Biomaterials 28 (2007), Aug. 13, 2007, pp. 5185-5192.

The hydrogels can be photocured including UV cured. The hydrogels can be functionalized. The hydrogel crosslink density can be adapted for the application.

The material of the second composition, such as a hydrogel, can be adapted to not interact with cells. They can be engineered to release the assay material at a variety of rates (e.g., minutes, hours, days).

### Material Adapted to Prevent Non-Specific Binding

The substrate surface can be also treated to prevent non-specific binding. Known cell blocking agents can be used. For example, PBS solutions can be used. For example, at least one blocking solution is used to treat the substrate surface after the deposition of the patterns. The blocking solution can be 1-2% bovine serum albumin in PBS, 5% fetal calf serum in PBS, 10% goat serum in PBS, or any other composition that can block the non-specific binding of cells.

### CELLS

Cells can be bound to the substrate via the cell binding materials. A wide variety of cells are known and can be used. See, for example, Pollard and Earnshaw, Cell Biology, 2^{nd} Ed., 2008.

Stem cells can be used. See, for example, Lanza (Ed.), Essentials of Stem Cell Biology, 2006.

The cell can be, for example, prokaryotic and eukaryotic cells, normal and transformed cell lines, cells from transgenic animals, transduced cells, neoplastic cells, cells with reporter genes or other biochemical reporters, cells associated with any disease, and cultured cells, which may be derived from animal, bacteria, plant, fungus, viruses, prions, or with respect to tissue origin, heart, lung, liver, brain, vascular, lymph node, spleen, pancreas, thyroid, esophageal, intestine, stomach, thymus, malignancy, atheroma, pathological lesion, and the like.

### Articles

The methods described herein can be used to prepare articles. These articles can be called a microarray. They can comprise the substrate both before and after the cell is disposed on the substrate.

Kits can also be provided including instructions and components described herein.

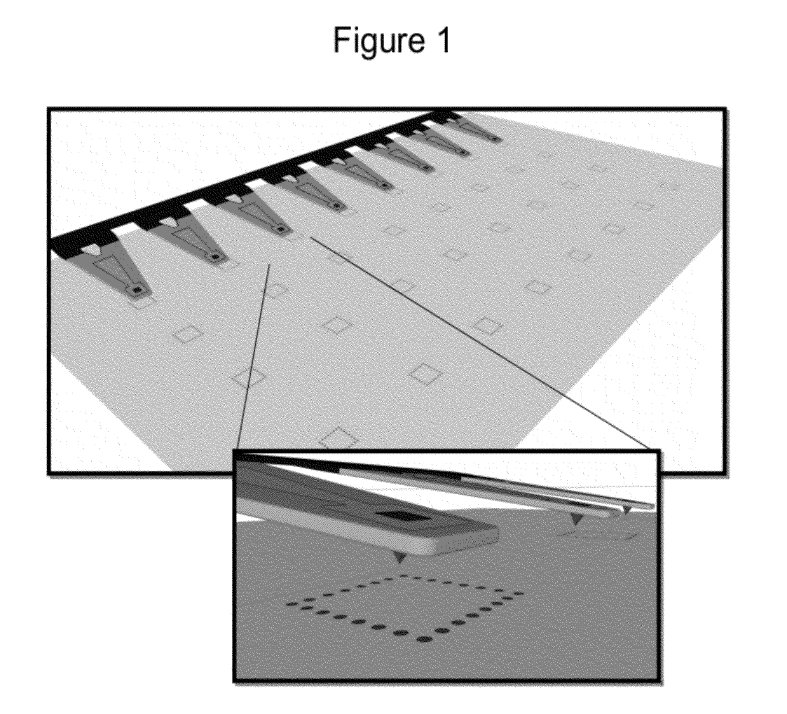

### Embodiments of FIGS. 1-8

Additional embodiments are described in the figures.

For example, FIG. 1 shows an embodiment wherein a cell adhesion material is patterned on a substrate which can be glass. The cell adhesion material is patterned in the form of a series of dots forming a square or rectangle, which provides for interior space within the square or rectangle. Multiple tips can be used. The length and/or width of the rectangle or square can be adapted to match a cell dimension and can be about, for example, 30 microns to about 50 microns. A plurality of the squares and rectangles can be patterned.

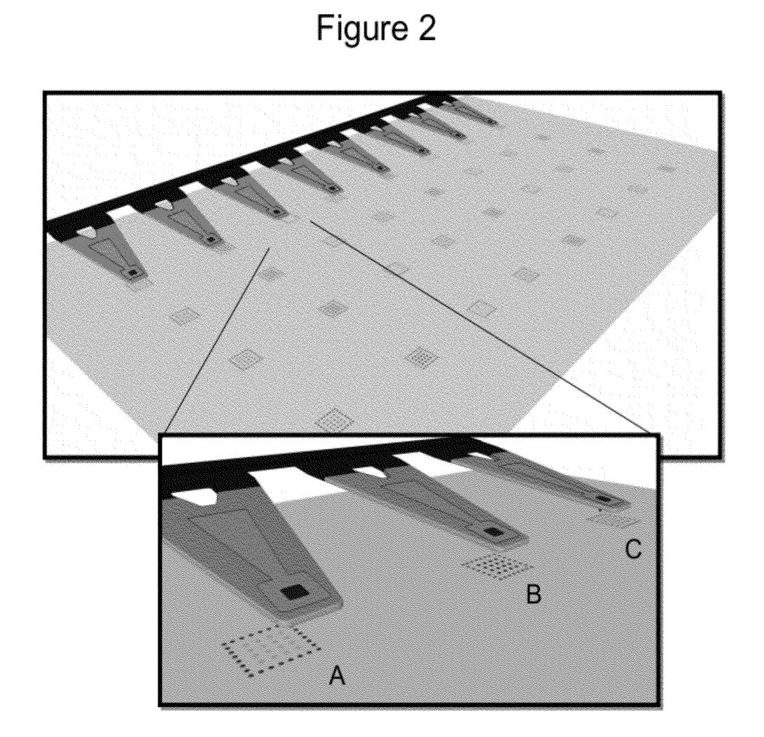

FIG. 2 shows an embodiment wherein at least one biodegradable material is deposited and patterned inside the squares or rectangles of FIG. 1. If desired, another set of tips can be used. The biodegradable material can be mixed with a material adapted to affect or potentially affect cell function. Multiplexed deposition can be used, and multiple assays on a single chip can be carried out.

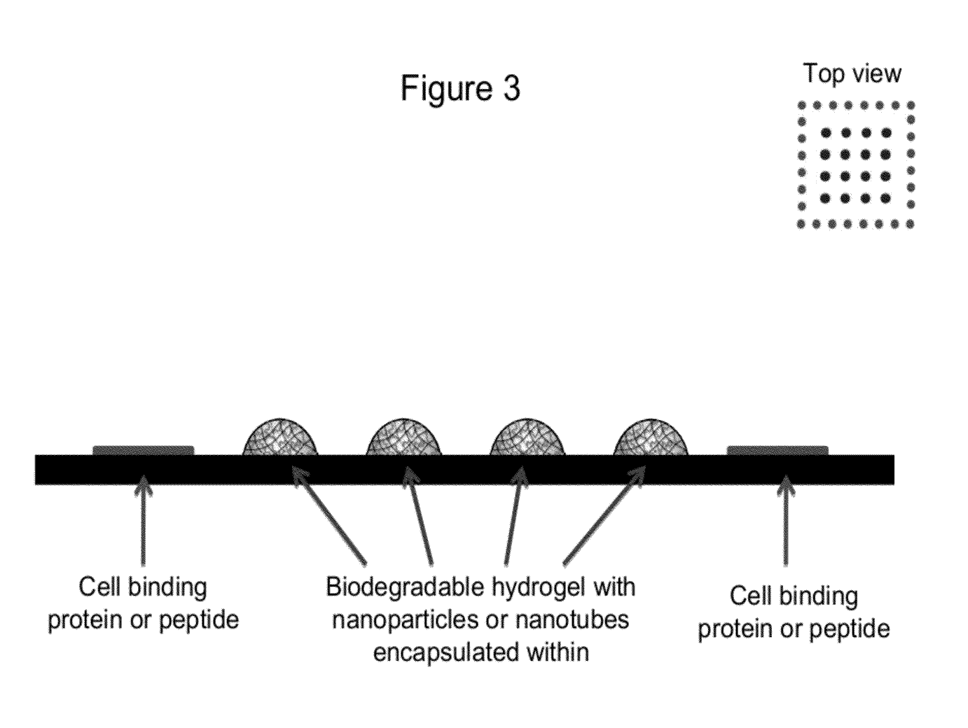

FIG. 3 shows an embodiment comprising a cross-sectional view of the chip fabricated in FIGS. 1 and 2, wherein the cell binding material is on the outside and the biodegradable material is on the inside. FIG. 3 also shows a top view including the outside and inside pattern.

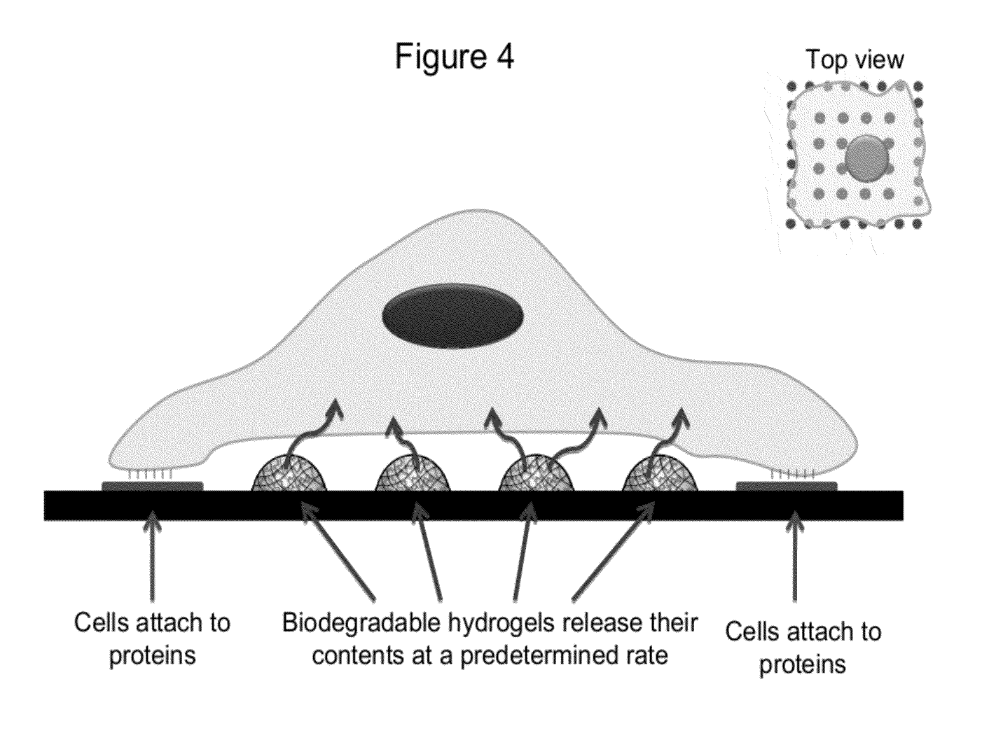

FIG. 4 illustrates an embodiment comprising a cell binding to the cell binding materials. This positions the cell so it can interact with and be exposed to the underlying biodegradable material and the material adapted to affect or potentially affect the cell. Materials can be released from the biodegradable material at a predetermined rate.

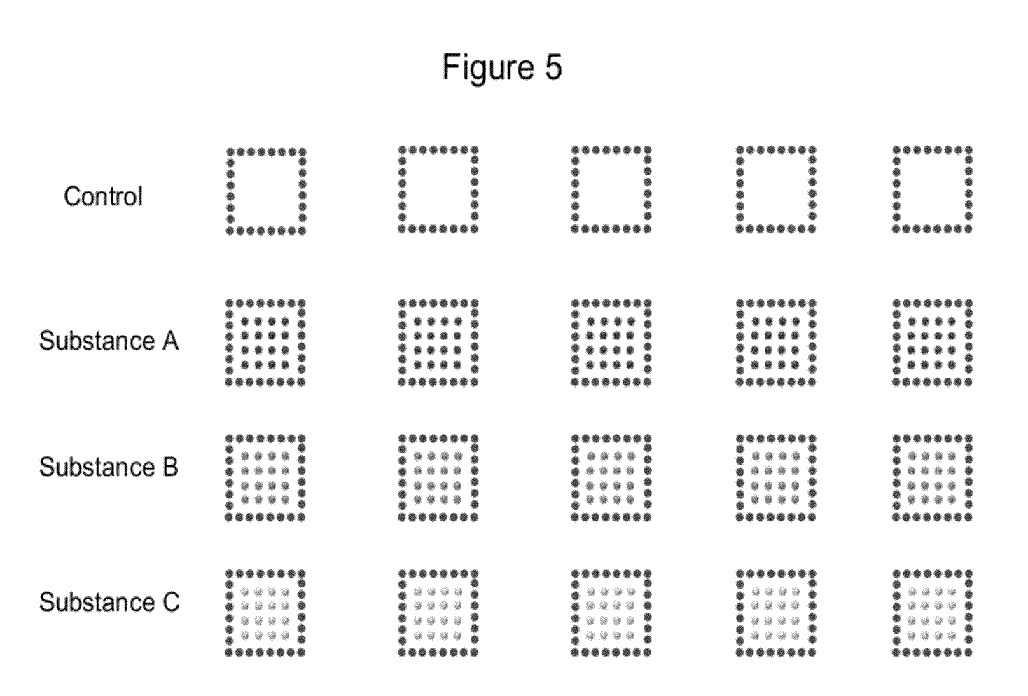

FIG. 5 illustrates an embodiment with a top view for patterning with a control and three different substances A, B, and C.

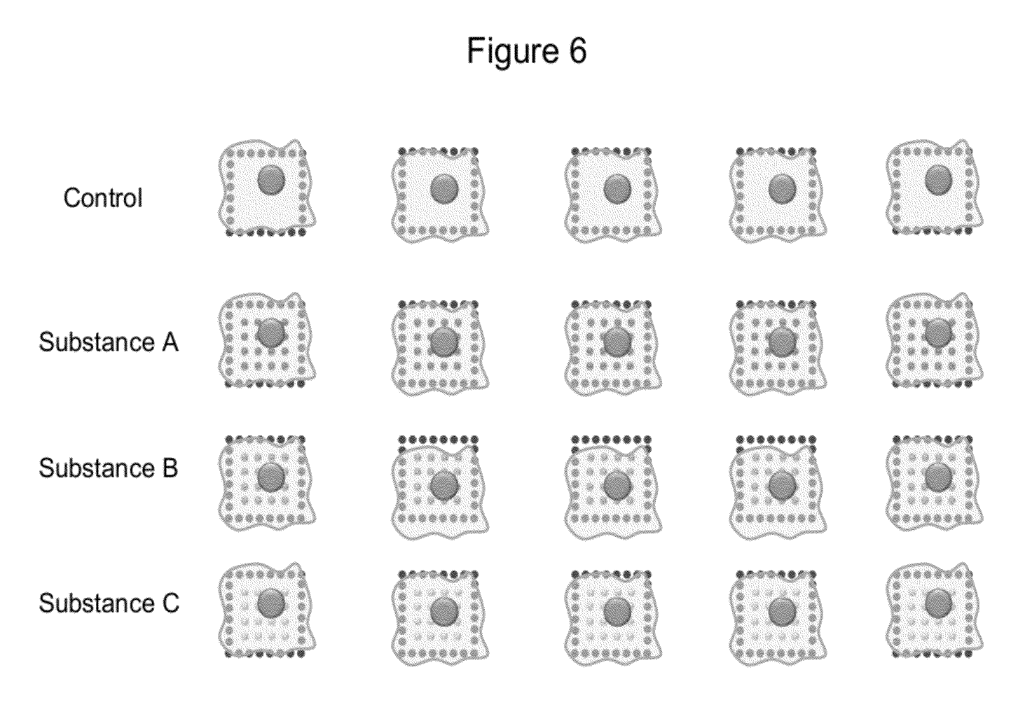

FIG. 6 illustrates the embodiment of FIG. 5 wherein the cell has now bound to the cell binding materials on the outside of the patterns.

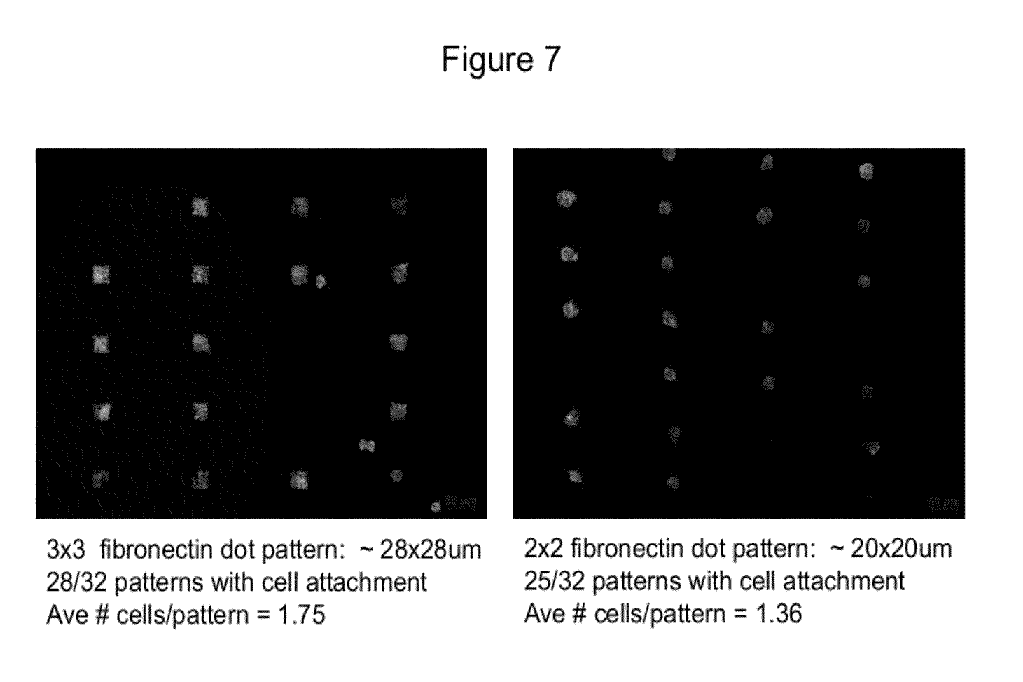

FIG. 7 (left) shows 3×3 fibronectin dot pattern; about 28 microns X about 28 microns. 28 of the 32 patterns had cell attachment (88%). The average number of cells per pattern is 1.75. FIG. 7 (right) shows 2×2 fibronectin dot pattern; about 20 microns X about 20 microns. 25 of the 32 patterns had cell attachment (78%). The average number of cells per pattern is 1.36.

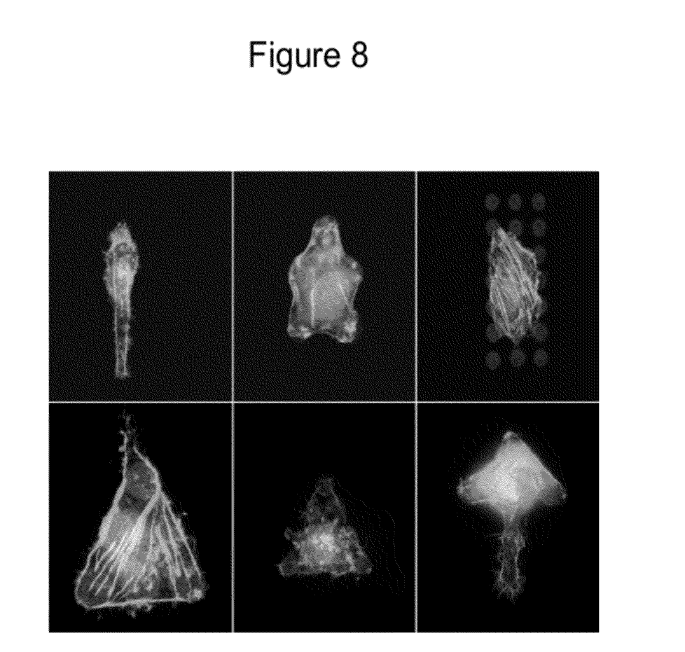

FIG. 8 shows six examples of different types of cell attachments.

### Cell Assays

A cell assay can be, for example, any drug or material which can be put in, for example, a hydrogel and release to the bound cells. Testing multiple drugs/materials on a single piece of glass can be carried out.

The cell assay can be, for example, cytokines, chemokines, differentiation factors, growth factors, soluble receptors, prostaglandins, steroids, pharmacologically active drugs, genetically active molecules, chemotherapeutic agents, anti-inflammatory agents, hormones or hormone antagonists, ion channel modifiers, neuroactive agents, toxins, biological and chemical warfare agents, nanoparticles, nanotubes, and any other small proteins or small molecules that affect or potentially affect cellular function.

Assays are also described in, for example, US Patent Publication 2004/0248144.

### Other Applications

Cell sorting can be carried out by patterning different cell binding materials. Other applications include, for example, examination of cell polarization, cell contractility, multipolar divisions, toxicology, cell signaling, quantitative cell phenotyping, cell division and mitotic spindle orientation, cell polarity and organelle positioning, microtube network, and cell shape and actin cytoskeleton.

### LITERATURE

Additional applications and teachings are described in the following references:

### Patent or Published Patent Application:

1. U.S. Pat. No. 6,635,311 “Methods Utilizing Scanning Probe Microscope Tips And Products Therefor Or Produced Thereby.”
2. US 2003/0044389 “Microarrays for cell phenotyping and manipulation.”
3. US 2006/0019235 “Molecular and functional profiling using a cellular microarray.”
4. US 2006/0160066 “Cellular microarrays for screening differentiation factors.”
5. US 2005/0009206 “Peptide and Protein Nanoarrays and Direct-Write Nanolithographic Printing of Peptides and Proteins.”

### Non Patent Literatures:

1. Chen & Davis, “Molecular and functional analysis using live cell microarrays.” Curr. Opin. Chem. Biol., 10:28-34 (2006).
2. Wheeler et al., “Cell microarrays and RNA interference chip away at gene function.” Nature Genetics, 37:S25-S30 (2005).
3. Kononen et al., “Tissue microarrays for high-throughput molecular profiling of tumor specimens.” Nat. Med., 4:844-847 (1998).

### WORKING EXAMPLES

### Example 1

A biodegradable hydrogel with a compound of interest was patterned onto functionalized glass slides. A photo-curing step followed for approximately 10 minutes. Hydrogel patterns were then located using the NLP 2000 optical system, and the substrate was aligned for ECM protein deposition. ECM protein was added to protein carrier solution in a 5:3 ratio. DPN patterning was used to pattern the functionalized glass surface around or near the previously printed hydrogel. Pattern size and shape can be changed easily. The protein-functional surface reaction was allowed to proceed for several hours. The surface was then rinsed with buffer solution (PBS) and a blocking solution was added, consisting of 2% bovine serum albumin in PBS. After 2-4 hours of blocking, solution was removed. Cells were added at high density (100,000 cells/cm²) in defined media and allowed to attach undisturbed for 30 minutes at 37° C. and 5% CO². After 30 minutes, substrates were washed with pre-warmed PBS gently twice. After microscopic observation to determine cell attachment, a more careful washing step whereby a manual pipette was used to create a more forceful flow of solution over the patterned area removes the remaining unattached cells near the patterned areas. Greater than 75% of patterned areas show cell attachment. Cells and printed material were then stained to observe specific cell reactions to surface conditions.

### Example 2

An exemplary method is described here for patterning cells onto surfaces using direct deposition of extracellular matrix (ECM) proteins and for delivering multiple compounds to individual cells. First, actin polymerization and stress fiber formation was followed over a 2 hour time period. Second, multiple ECM proteins were patterned on the same substrate and side-by-side analysis of single cells was done to characterize differential responses. Finally, polyethylene glycol with or without Cytochalasin-D (250 μM or 500 μM) was delivered to individual cells. A method was established for single cell analysis with multiple compounds on the same substrate. The NLP 2000 (NanoInk, Inc., Skokie, Ill.) fabrication system was used for patterning of ECM proteins and hydrogel composites. After approximately 4 hours, substrates were rinsed and non-specific cell binding is blocked with a solution of bovine serum albumin. NIH 3T3 fibroblasts (ATCC) were added at high density for 30 minutes, at which point non-adherent cells are washed and removed. Complete media was then added for between 0.5 and 3.5 hours before paraformaldehyde fixation, staining and analysis. Cells attach to approximately 75% of the patterns deposited onto glass surfaces. Cell morphology was controlled and actin polymerization was more developed with more elongated stress fibers at 2 hours versus earlier time points. Delivery of Cytochalasin-D in PEG and the corresponding decline in cell spreading and migration demonstrates the ability to address single cells with multiple compounds. Combinatorial experimentation is increasingly important with regard to the cellular microenvironment. Here, cell patterning with ECM proteins and PEG hydrogel, for delivery of Cytochalasin-D, demonstrates a simple, flexible and fast method of targeting single to few cells with multiple factors for analysis on a single substrate.

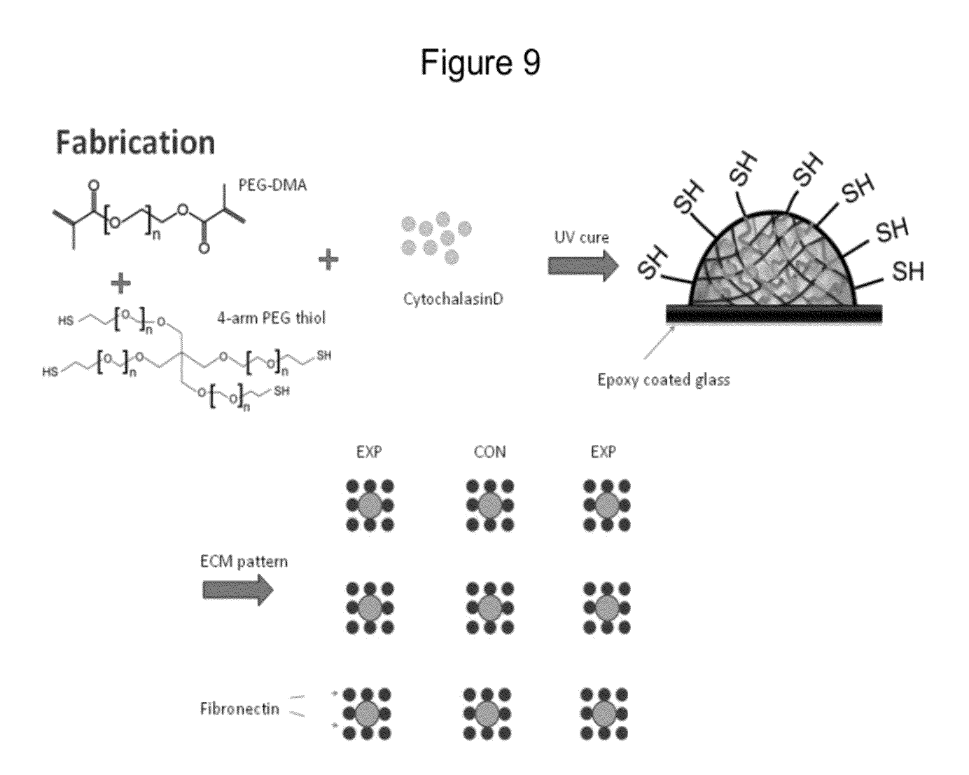

FIG. 9 shows an example of the fabrication of the hydrogel pattern described herein. A mixture of PEG-DMA, 4-arm PEG thiol, and Cytochalasin D, a compound of interest, is patterned onto an epoxy-coated glass slide. After curing with UV, fibronectin, an ECM protein, was patterned onto the glass slide around the cured hydrogel. In a control hydrogel pattern, only PEG-DMA and 4-arm PEG thiol, but not any compound of interest, were used for fabricating the hydrogel.

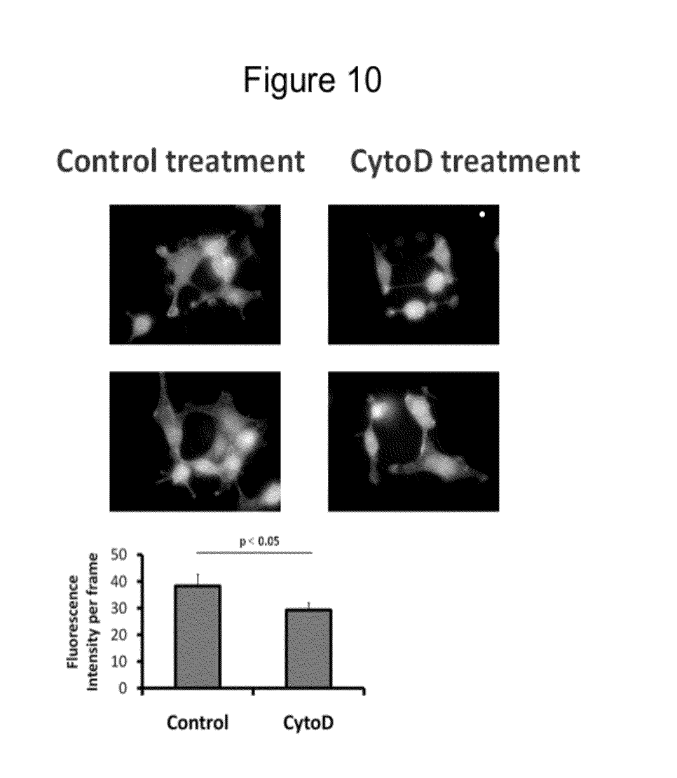

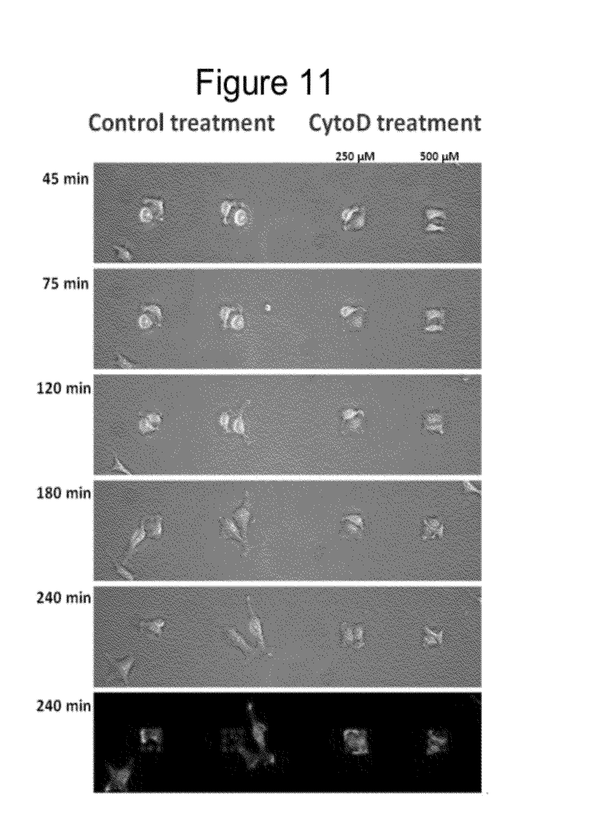

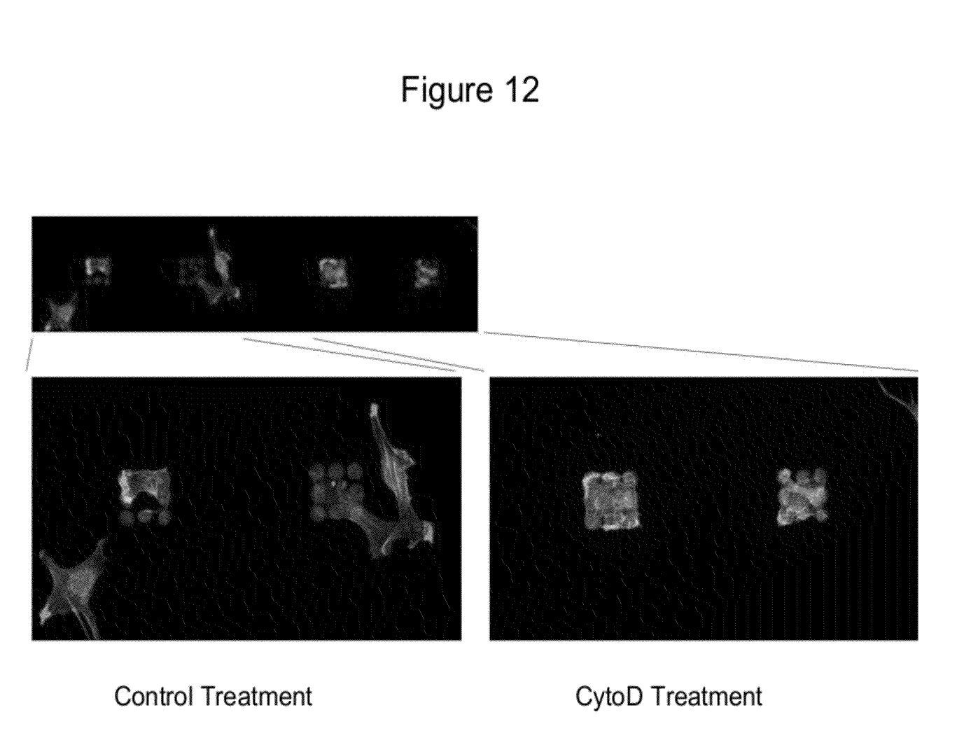

Subsequently, 3T3 fibroblasts were plated onto the glass slide with PEG and fibronectin as described above. As shown in FIG. 10, cells were cultured for 2 hours, and then images are collected and average fluorescence intensity is determined. With Cytochalasin D in the PEG hydrogel, there is significantly fewer cells and less spreading and/or migration away from the patterns (results are mean+/−SE for 15 patterns per group). FIGS. 11 and 12 show the time course following spreading and migration of fibroblasts over a period of 4 hours. Cytochalasin D (250 and 500 μM) prevented migration of fibroblasts from the fibronectin patterned area whereas cells spread and migrate with control treatment (PEG without CytoD).

What is claimed is:

1. A method comprising:
depositing at least one first composition comprising at least one cell adhesion material on at least one substrate to form a pattern which, optionally, forms an interior space on the substrate within the pattern, depositing on the substrate at least one second composition, different from the first, comprising at least one material adapted to affect or potentially affect cell function, wherein after deposition of the first composition and the second composition, optionally, the second composition is disposed in the interior space.

2. The method of claim 1, wherein depositing of the first composition occurs before depositing of the second composition, or the depositing of the second composition occurs before depositing of the first composition.

3. The method of claim 1, wherein the second composition further comprises at least one gel.

4. The method of claim 1, wherein the second composition further comprises at least one hydrogel.

5. The method of claim 1, wherein the second composition further comprises at least one synthetic polymer.

6. The method of claim 1, wherein the second composition further comprises at least one biodegradable material.

7. The method of claim 1, wherein the second composition comprises at least one material adapted to provide controlled release of the material adapted to affect or potentially affect cell function.

8. The method of claim 1, wherein the second composition comprises at least one encapsulant.

9. The method of claim 1, wherein the first composition deposition step is carried out with at least one tip to transfer the first composition to the substrate.

10. The method of claim 1, wherein the first composition deposition step is carried out with at least one nanoscopic tip to transfer the first composition to the substrate.

11. The method of claim 1, wherein the second composition deposition step is carried out with a least one tip to transfer the second composition to the substrate.

12. The method of claim 1, wherein the second composition deposition step is carried out with a least one nanoscopic tip to transfer the biodegradable material to the substrate.

13. The method of claim 1, further comprising the step of binding at least one cell to the pattern.

14. The method of claim 1, further comprising the step of binding one cell to five cells to the pattern.

15. The method of claim 1, further comprising the step of binding about one cell to the pattern.

16. The method of claim 1, further comprising treating the substrate with a material adapted to prevent non-specific cell binding.

17. The method of claim 1, wherein the cell adhesion material comprises at least one protein or peptide.

18. The method of claim 1, wherein the cell adhesion material comprises at least one extracellular matrix.

19. The method of claim 1, wherein the cell adhesion material comprises at least one cell receptor.

20. The method of claim 1, wherein the material adapted to affect or potentially affect cell function comprises at least one nanomaterial.

21. The method of claim 1, wherein the material adapted to affect or potentially affect cell function comprises at least one pharmaceutical drug.

22. The method of claim 1, wherein the one material adapted to affect or potentially affect cell function comprises at least one toxin.

23. The method of claim 1, wherein the substrate is a rigid substrate.

24. The method of claim 1, wherein the substrate is a flexible substrate.

25. The method of claim 1, wherein the deposition of the first composition forms a plurality of dots, and the pattern of dots is a square or rectangle.

26. The method of claim 1, wherein the pattern has a lateral dimension of less than about 100 microns.

27. The method of claim 1, wherein the pattern has a lateral dimension of less than about 50 microns.

28. The method of claim 1, wherein the deposition of the first composition and the deposition of the second composition produce dots on the substrate with dot diameter of less than about one micron.

29. The method of claim 1, wherein the deposition of the first composition is reproduced to produce at least two patterns on the same substrate with internal space.

30. The method of claim 1, wherein the pattern forms an interior space on the substrate within the pattern, wherein after deposition of the first composition and the second composition, the second composition is disposed in the interior space, wherein the deposition of the first composition and the deposition of the second composition are each carried out by direct write methods, wherein the second composition further comprises at least one hydrogel, wherein the first composition deposition step is carried out with at least one tip to transfer the first composition to the substrate, and wherein the second composition deposition step is carried out with a least one tip to transfer the second composition to the substrate.

31. An article comprising:
at least one substrate comprising at least one pattern of cell adhesion material, wherein optionally the pattern forms an interior space on the substrate within the pattern,
at least one material, optionally, in the interior space on the substrate, different from the cell adhesion material, wherein the material optionally in the interior space is adapted to affect or potentially affect cell function.

32. The article of claim 31, wherein the material adapted to affect or potentially affect cell function is adapted for controlled release.

33. The article of claim 31, wherein the material adapted to affect or potentially affect cell function is adapted for controlled release from a gel.

34. The article of claim 31, wherein the material adapted to affect or potentially affect cell function is adapted for controlled release from a hydrogel.

35. The article of claim 31, the article further comprising at least one cell disposed on the pattern.

36. The article of claim 31, the article further comprising at least one material on the surface of the substrate which is adapted to prevent non-specific cell binding.

37. The article of claim 31, wherein the pattern comprises a series of dots.

38. The article of claim 31, wherein the pattern comprises a rectangle or square.

39. The article of claim 31, wherein the pattern has a lateral dimension of about 100 microns or less.

40. The article of claim 31, wherein the pattern forms an interior space on the substrate within the pattern, and the at least one material which is adapted to affect or potentially affect cell function is disposed in the interior space on the substrate.

41. A microarray comprising:
at least one substrate,
at least one cell binding pattern fixed on the substrate and binding one or more cells, wherein each of the cell binding patterns is capable of binding no more than five cells;
at least one hydrogel pattern fixed on the substrate and different from the cell binding pattern, wherein each of the hydrogel patterns comprises a cell assay material adapted to be released to contact cells bound to the cell binding pattern,
wherein the substrate is further blocked in areas not occupied by the cell binding patterns or hydrogel patterns to prevent non-specific cell binding.

42. The microarray of claim 41, wherein each of the hydrogel patterns is fixed within one of said cell binding patterns.

43. The microarray of claim 41, wherein more than one kind of the cell assay material is present on the substrate.

44. A method comprising:
depositing at least one first composition comprising at least one cell adhesion material on at least one substrate to form a pattern which forms an interior space on the substrate within the pattern,
depositing in the interior space on the substrate at least one second composition, different from the first, comprising at least one material adapted to affect or potentially affect cell function.

45. A method for producing microarrays comprising:
fixing multiple hydrogel patterns onto a substrate, wherein each of the hydrogel patterns comprises a cell assay material,
locating the hydrogel patterns being fixed on the substrate,
fixing multiple cell binding patterns onto the substrate next to the hydrogels,
blocking areas of the substrate not occupied by the cell binding pattern or the hydrogel patterns.

46. A method comprising: depositing with a nanoscopic tip at least one first composition comprising at least one cell adhesion material on at least one substrate to form a pattern which, optionally, forms an interior space on the substrate within the pattern, depositing with a nanoscopic tip on the substrate at least one second composition, different from the first, comprising at least one material adapted to affect or potentially affect cell function, wherein after deposition of the first composition and the second composition, optionally, the second composition is disposed in the interior space,
wherein depositing of the first composition occurs before depositing of the second composition, or the depositing of the second composition occurs before depositing of the first composition,
and wherein the pattern forms an interior space on the substrate within the pattern, wherein after deposition of the first composition and the second composition, the second composition is disposed in the interior space.

47. The method of claim 46, wherein the nanoscopic tips are disposed at the end of cantilevers and perpendicular to the cantilever.

48. The method of claim 46, wherein the nanoscopic tips are atomic force microscope tips.

49. A kit adapted for a cellular assay, wherein the kit comprises at least one of (i) instructions to use the kit for cellular assay, (ii) at least one substrate, (iii) at least one cellular adhesion material, (iv) at least one one material for cellular assay, (v) an encapsulant.

50. A method comprising:
depositing at least one first composition comprising at least one cell adhesion material on at least one substrate to form a pattern which, optionally, forms an interior space on the substrate within the pattern, depositing on the substrate at least one second composition, different from the first, comprising at least one material adapted to affect or potentially affect cell function, wherein after deposition of the first composition and the second composition, optionally, the second composition is disposed in the interior space, wherein the pattern totally surrounds the interior space or the pattern only partly surrounds the interior space.

51. The method of claim 50, wherein the pattern totally surround the interior space.

52. The method of claim 50, wherein the pattern comprises dots which totally surround the interior space.

53. The method of claim 50, wherein the pattern comprises dots which do not touch one other and which totally surround the interior space.

54. A product prepared by the process of claim 1.

55. The method of claim 1, wherein the cell adhesion material comprises at least one of fibronectin, laminin, collagen I, collagen IV, gelatin, poly-I-lysine, BD ECM, BD Matrigel, tenacin C, and vitronectin.

56. The method of claim 1, wherein the second composition further comprises at least one of gelatin, PLGA, and Euragit.

57. The method of claim 1, wherein the material adapted to affect or potentially affect cell function comprises Cytochalasin D.
